(19) United States
(12) Patent Application Publication
(10) Pub. No.: US 2026/0055243 A1
(43) Pub. Date: Feb. 26, 2026

(54) GREEN PREPARATION METHOD FOR GRANULAR PLASTIC ADDITIVES

(71) Applicant: BASF SE, Ludwigshafen am Rhein (DE)

(72) Inventors: Michael SCHMITT, Worms (DE); Thomas Georg GFROERER, Kaisten (CH); Thomas SCHUSTER, Roemerberg (DE); Laurent CAVIN, Kaisten (CH); Elena CAPITO', Pontecchio Marconi (IT); Elisa MONTRONI, Pontecchio Marconi (IT); Andrea FRANCHI, Pontecchio Marconi (IT); Christian KRANEMANN, Muttenz (CH)

(21) Appl. No.: 19/104,190

(22) PCT Filed: Aug. 7, 2023
(86) PCT No.: PCT/EP2023/071773

§ 371 Date: Feb. 14, 2025

(30) Foreign Application Priority Data
Aug. 16, 2022 (EP) 22190569.8

(51) Int. Cl. C08J 3/12; C08J 3/20; C08J 3/22; C08K 5/3492; C08K 11/00

(52) U.S. Cl. CPC C08J 3/12; C08J 3/201; C08J 3/226; C08K 5/34926; C08K 11/00; C08J 2323/02

(57) ABSTRACT

The present invention relates to a method for preparing a granular plastic additive comprising the steps of
a) providing at least one additive solution which comprises a plastic additive and a solvent,
b) optionally mixing the additive solutions,
c) thin film evaporation of the additive solution to produce a concentrated additive,
d) agitation of the concentrated additive under vacuum to produce a hot melt,
e) mixing a molten carrier polymer with the concentrated additive during the extrusion, and
f) cooling and forming the hot melt comprising the plastic additive and the carrier polymer to produce the granular plastic additive.

The invention also relates to the granular plastic additive obtainable by the method.

The present invention relates to a method for preparing a granular plastic additive comprising the steps of
a) providing at least one additive solution which comprises a plastic additive and a solvent,
b) optionally mixing the additive solutions,
c) thin film evaporation of the additive solution to produce a concentrated additive,
d) agitation of the concentrated additive under vacuum to produce a hot melt,
e) mixing a molten carrier polymer with the concentrated additive during the extrusion, and
f) cooling and forming the hot melt comprising the plastic additive and the carrier polymer to produce the granular plastic additive.

The invention also relates to the granular plastic additive obtainable by the method.

Organic polymers generally require the addition of plastic additives in order to facilitate processing and to retain the in-use properties for as long a period as possible. Factors having a damaging effect on organic polymers, in addition to light and heat, also include residues of catalysts used during preparation. In general, the additives and additive mixtures can be in powder, granules, or solution form.

Object was to find a method for preparation of granular plastic additives, which are uniformly shaped, have adjustable particle size, good flowability, considerable resistance to attrition, low levels of dust, good storage stability, they can be readily metered into the organic polymers to be stabilized. Another advantage of the method for preparation of granular plastic additives is a significant simplification of the procedure to obtain a final product for sales, and removing most of the handling of powders. Finally, there is a sustainability advantage in avoiding the drying from precipitation in water with a net reduction of energy requirements.

The objects were achieved by a method for preparing a granular plastic additive comprising the steps of
a) providing at least one additive solution which comprises a plastic additive and a solvent,
b) optionally mixing the additive solutions,
c) thin film evaporation of the additive solution to produce a concentrated additive,
d) agitation of the concentrated additive under vacuum to produce a hot melt,
e) mixing a molten carrier polymer with the concentrated additive during the extrusion, and
f) cooling and forming the hot melt comprising the plastic additive and the carrier polymer to produce the granular plastic additive.

The objects were also achieved by the granular plastic additive obtainable by the method.

### Step a)

The step a) is providing at least one additive solution which comprises the plastic additive and the solvent.

The additive solution comprises the plastic additive and the solvent. The additive solution may comprise at least one, e.g. one, two or three of the plastic additives. Preferably, the additive solution comprises one plastic additive and the solvent. The additive solution may be provided at room temperature or at elevated temperatures, e.g. up to a few degrees below the boiling point of the solution, e.g. from 10 to 100° C. The additive solution is preferably provided at least 50° C., and in particular at least 70° C.

At least one additive solution is provided, such as one, two or three additive solutions. In a preferred form, one additive solution is provided and step b) of mixing the additive solutions does not apply. In another preferred form, at least two additive solutions are provided and step b) of mixing the additive solutions does apply. In case at least two additive solutions are provided each additive solution may contain a different plastic additive. In case at least two additive solutions are provided each additive solution may contain the same solvent or different solvents.

The solvent can be any solvent or a mixture of different solvents. Often the solvent is a solvent which was used in the previous synthesis of the plastic additive. Preferably, the solvent comprises toluene, xylene, ethylbenzene, trimethylbenzene, isopropylbenzene, diisopropylbenzene, a water-insoluble organic ketone (e.g. methyl ethyl ketone, or methyl isobutyl ketone), or mixtures thereof. In particular, the solvent comprises xylene, ethylbenzene and toluene, and especially xylene. The solvent typically comprises at least 60, 80 or 90 wt % of toluene, xylene, ethylbenzene, trimethylbenzene, isopropylbenzene, diisopropylbenzene, the water-insoluble organic ketone, or mixtures thereof. The solvent typically comprises preferably at least 60, 80 or 90 wt % of xylene.

The additive solution comprises at least 15, 25, 35, 40 or 45 wt % of the solvent. Preferably, the additive solution comprises at least 25 wt %, and in particular at least 50 wt % of the solvent.

Suitable plastic additives are any plastic additive, such as antioxidants, UV absorbers, light stabilizers, metal deactivators, phosphites, phosphonates, hydroxylamines and amine N-oxides, nitrones, thiosynergists, peroxide scavengers, acid scavengers, basic-co-stabilizers, nucleating agents, benzofuranones and indolinones, and flame retardants.

Suitable antioxidants are:

### 1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethyl-phenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, 2,4-dimethyl-6-(1′-methyl-1′-tetradecyl-methyl)-phenol and mixtures thereof.
1.2. Alkylthiomethylphenols, for example 2,4-dioctylthiomethyl-6-tert-butylphenol, 2,4-dioctylthio-methyl-6-methylphenol, 2,4-dioctylthiomethyl-6-ethylphenol, 2,6-di-dodecyl-thiomethyl-4-nonyl-phenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octadecyl-oxy-phenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol and mixtures thereof (vitamin E), vitamin E acetate. Especially preferred is the addition of 2,5,7,8-tetramethyl-2-[4,8,12-trimethyltridecyl]-chroman-6-ol], which is a commercially available vitamin E (e.g. Irganox E 201™).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(a-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane.
1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetra-methylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexa-hydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid, (3,5-ditert-butyl-4-hydroxy-phenyl)methylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, for example with methanol, ethanol, n-octanol, i-octanol, a mixture of linear and branched C₇-C₉-alkanol, octadecanol, a mixture of linear and branched C₁₃-C₁₅-alkanol, 1,6-hexanediol, 1,9-nonanediol, ethylene glycol, 1,2-propanediol, neopentyl glycol, thiodiethylene glycol, diethylene glycol, triethylene glycol, tetraethylene glycol, pentaerythritol, tris-(hydroxyethyl)isocyanurate, N,N′-bis-(hydroxy-ethyl)oxamide, 3-thiaundecanol, 3-thiapenta-decanol, trimethylhexanediol, trimethylolpropane, 4-hydroxymethyl-1-phospha-2,6,7-trioxabicyclo[2.2.2]octane. Preferred are esters of β-(3,5-di-tert-butyl-4-hydroxyphenyl)propionic acid, especially with octadecanol, such as the addition of Octadecyl-3-(3,5-di-tert.butyl-4-hydroxyphenyl)-propionate, which is a commercially available as e.g. Irganox 1076™.
1.14. Esters of β-(5-tert-butyl-4-hydroxy-3-methylphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.
1.15. Esters of β-(3,5-dicyclohexyl-4-hydroxyphenyl)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)ox-amide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid, for example N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenyl-propionyl)hydrazide, N,N′-bis[2-(3-[3,5-di-tert-butyl-4-hydroxyphenyl]propionyloxy)ethyl]oxamide (Naugard XL-1).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclo-hexyl-p-phenylenediamine, N,N′-diphenyl-p-phenylenediamine, N,N′-bis(2-naphthyl)-p-phenyl-enediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethyl-aminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines or a mixture of mono- and dialkylated tert-octylphenothiazines, N-allylphenothiazine, N,N,N′,N′-tetraphenyl-1,4-diaminobut-2-ene, N-[(1,1,3,3-tetramethylbutyl)phenyl]-1-napthalenamine] (commercially available as Irganox L06™).

Suitable UV absorbers and light stabilizers are:

### 2. UV Absorbers and Light Stabilizers

2.1. 2-(2′-Hydroxyphenyl)benzotriazoles, for example 2-(2′-hydroxy-5′-methylphenyl)benzo-triazole, 2-(3′,5′-di-tert-butyl-2′-hydroxyphenyl)benzotriazole, 2-(5′-tert-butyl-2′-hydroxyphenyl)-benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyl-oxycarbonylethyl)phenyl)-5-chlorobenzotriazole, 2-(3′-tert-butyl-5′-[2-(2-ethylhexyloxy)carbonyl-ethyl]-2′-hydroxyphenyl)-5-chlorobenzotriazole, 2-(3′-tert-butyl-2′-hydroxy-5′-(2-methoxycarbon-ylethyl)phenyl)-5-chlorobenzotriazole, 2-(3′-tert-butyl-2′-hydroxy-5′-(2-methoxycarbonylethyl)-phenyl)benzotriazole, 2-(3′-tert-butyl-2′-hydroxy-5′-(2-octyloxycarbonylethyl)phenyl)benzotri-azole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxy-carbonylethyl)phenylbenzotriazole, 2,2′-methylenebis[4-(1,1,3,3-tetramethylbutyl)-6-benzo-triazole-2-ylphenol]; the transesterification product of 2-[3′-tert-butyl-5′-(2-methoxycarbonyl-ethyl)-2′-hydroxyphenyl]-2H-benzotriazole with polyethylene glycol 300; [R′—CH₂—CH₂—CO—O—CH₂—CH₂-]₂, where R′=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-(α,α-dimethylbenzyl)phenyl]benzotriazole.
2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)-resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.4. Acrylates, for example ethyl α-cyano-β,β-diphenylacrylate, isooctyl α-cyano-β,β-diphenyl-acrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate, N-(β-carbomethoxy-β-cyanovinyl)-2-methylindoline and neopentyl tetra(α-cyano-β,β-diphenylacryl-ate), or sterically hindered acrylates such as disclosed in EP-A-3587425, like for instance (2E,2′E)-2,4,8,10-tetraoxaspiro[5.5]undecane-3,9-diylbis(2-methylpropane-2,1-diyl) bis(2-cyano-3-(3,4-dimethoxyphenyl)acrylate) [CAS Reg. No. 2233585-18-5], or a similar derivative, wherein the one of the two OCH₃ groups (methoxy) of each of the (2-cyano-3-(3,4-dimethoxyphenyl)acrylate)moiety is respectively substituted with a OC₆H₁₃ group, resulting in a bis(2-cyano-3-(3-methoxy-4-hexyloxyphenyl)acrylate) derivative.
2.5. Nickel compounds, for example nickel complexes of 2,2′-thiobis[4-(1,1,3,3-tetramethyl-butyl)phenol], such as the 1:1 or 1:2 complex, with or without additional ligands such as n-butyl-amine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzyl-phosphonic acid, nickel complexes of ketoximes, e.g. of 2-hydroxy-4-methylphenylundecyl-ketoxime, nickel complexes of 1-phenyl-4-lauroyl-5-hydroxypyrazole, with or without additional ligands.
2.6. Sterically hindered amines (also known as HALS), for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperid-4-yl)sebacate, bis(1-octyloxy-2,2,6,6-tetramethylpiperid-4-yl)succinate, bis-[2,2,6,6-tetramethyl-1-(undecyloxy)-piperidin-4-yl]carbonate, linear or cyclic condensates of N,N′-bis(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropyl-amino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperid-yl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanedi-amine and 2,4,6-trichloro-1,3,5-triazine as well as N,N-dibutylamine and 4-butylamino-2,2,6,6-tetramethylpiperidine (CAS Reg. No. [192268-64-7]); reaction products of N6,N6′-hexane-1,6-diylbis[N2,N4-dibutyl-N2,N4,N6-tris(2,2,6,6-tetramethylpiperidin-4-yl)-1,3,5-triazine-2,4,6-triamine], butanal and hydrogen peroxide; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)-ethene, N,N′-bis-formyl-N,N′-bis(2,2,6,6-tetramethyl-4-piperidyl)hexamethylenediamine, a diester of 4-methoxymethyl-enemalonic acid with 1,2,2,6,6-pentamethyl-4-hydroxy-piperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-amino-piperidine, a mixture of oligomeric compounds which are the formal condensation products of N,N′-bis-(2,2,6,6-tetramethyl-1-propoxy-piperidin-4-yl)-hexane-1,6-diamine and 2,4-dichloro-6-{n-butyl-(2,2,6,6-tetramethyl-1-propoxy-piperidin-4-yl)-amino}-[1,3,5]triazine end-capped with 2-chloro-4,6-bis-(di-n-butylamino)-[1,3,5]triazine, a mixture of oligomeric compounds which are the formal condensation products of N,N′-bis-(2,2,6,6-tetramethyl-piperidin-4-yl)-hexane-1,6-di-amine and 2,4-dichloro-6-{n-butyl-(2,2,6,6-tetramethyl-piperidin-4-yl)-amino}-[1,3,5]triazine end-capped with 2-chloro-4,6-bis-(di-n-butylamino)-[1,3,5]triazine, (N2,N4-dibutyl-N2,N4-bis(1,2,2,6,6-pentamethyl-4-piperidinyl)-6-(1-pyrrolidinyl)-[1,3,5]-triazine-2,4-diamine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. [106917-31-1]), 5-(2-ethylhexanoyl)-oxymethyl-3,3,5-trimethyl-2-morpholinone, the reaction product of 2,4-bis-[(1-cyclo-hexyloxy-2,2,6,6-piperidine-4-yl)butylamino]-6-chloro-s-triazine with N,N′-bis-(3-amino-propyl)ethylenediamine), 1,3,5-tris(N-cyclohexyl-N-(2,2,6,6-tetramethyl-piperazine-3-one-4-yl)amino)-s-triazine, 1,3,5-tris(N-cyclohexyl-N-(1,2,2,6,6-pentamethylpiperazine-3-one-4-yl)-amino)-s-triazine,
butanedioic acid, dimethylester, polymer with 4-hydroxy-2,2,6,6-tetramethyl-1-piperidine ethanol (CAS 65447-77-0),
poly[[6-[(1,1,3,3-tetramethylbutyl) amino]-1,3,5-triazine-2,4-diyl][(2,2,6,6-tetramethyl-4-piperidinyl) imino]-1,6-hexanediyl[(2,2,6,6-tetramethyl-4-piperidinyl) imino]]) (CAS 71878-19-8), polymer of 2,2,4,4-tetramethyl-7-oxa-3,20-diazadispiro[5.1.11.2]heneicosan-21-one hydrochloride and epichlorohydrin hydrolyzed (CAS 202483-55-4),
1,6-hexanediamine, N, N′-bis(2,2,6,6-tetramethyl-4-piperidinyl)-, polymers with morpholine-2,4,6-trichloro-1,3,5-triazine (CAS 193098-40-7)
1,2,3,4-butanetetracarboxylic acid, polymer with 2,2-bis(hydroxymethyl)-1,3-propanediol and 3-hydroxy-2,2-dimethylpropanal, 1,2,2,6,6-pentamethyl-4-piperidinyl ester (CAS 101357-36-2)
tetrakis(1,2,2,6,6-pentamethyl-4-piperidyl)1,2,3,4-butanetetracarboxylate (91788-83-9),
1,3,5-triazine-2,4,6-triamine, N, N′″-[1,2-ethane-diyl-bis [[[4,6-bis-[butyl (1,2,2,6,6-pentamethyl-4-piperidinyl) amino]-1,3,5-triazine-2-yl]imino]-3,1-propanediyl]]bis [N′, N″-dibutyl-N′, N″-bis(1,2,2,6,6-pentamethyl-4-piperidinyl)—(CAS 106990-43-6), or
a light stabilizer of formula (II) where X₂ is n-butyl

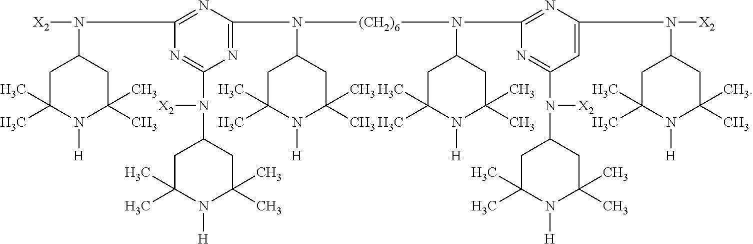

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxy-phenyl)-6-(2,4-dimethylphenyl)-1,3,5-triazine, 2-(2-hydroxy-4-octyloxyphenyl)-4,6-bis(4-methyl-phenyl)-1,3,5-triazine, 2-(2-hydroxy-4-dodecyloxyphenyl)-4,6-bis(2,4-dimethylphenyl)-1,3,5-tri-azine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(do-decyloxy/tridecyloxy-2-hydroxypropoxy)-2-hydroxyphenyl]-4,6-bis(2,4-dimethylphenyl)-1,3,5-tri-azine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)-phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

The plastic additive is preferably 1,6-hexanediamine, N1,N6-bis(2,2,6,6-tetramethyl-4-piperidinyl)-, polymer with 2,4,6-trichloro-1,3,5-triazine, reaction products wit h 3-bromo-1-propene, N-butyl-1-butanamine and N-butyl-2,2,6,6-tetramethyl-4-piperidinamine, oxidized, hydrogenated with the CAS number 247243-62-5.

The plastic additive comprises preferably a light stabilizer, a UV stabilizer, or a mixture thereof.

The plastic additive is preferably a condensate of 1,6-hexanediamine and 2,4,6-trichloro-1,3,5-triazine as well as N,N-dibutylamine and 4-butylamino-2,2,6,6-tetramethylpiperidine or a light stabilizer of the formula (I)

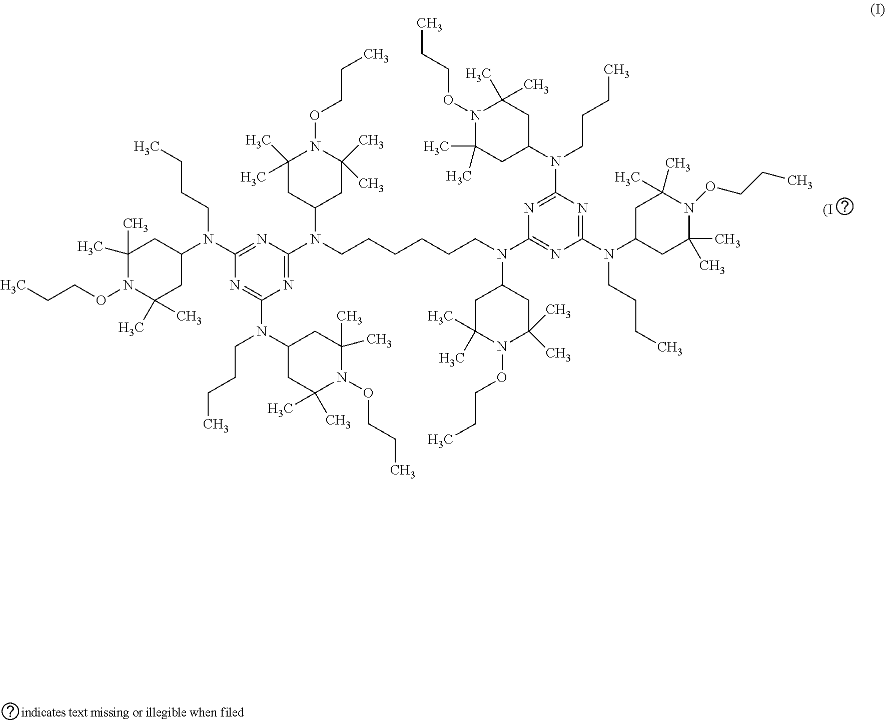 [SMILES: CCCCN(c1nc(N(CCCC)C2CC(C)(C)N(OCCC)C(C)(C)C2)nc(N(CCCCCCN(c2nc(N(CCCC)C3CC(C)(C)N(OCCC)C(C)(C)C3)nc(N(CCCC)C3CC(C)(C)N(OCCC)C(C)(C)C3)n2)C2CC(C)(C)N(OCCC)C(C)(C)C2)C2CC(C)(C)N(OCCC)C(C)(C)C2)n1)C1CC(C)(C)N(OCCC)C(C)(C)C1]

In particular the plastic additive comprises the light stabilizer of the formula (I).

In another preferred form the plastic additive comprises the light stabilizer of the formula (I) and a light stabilizer selected from the sterically hindered amines (e.g. the sterically hindered amines of the section 2.6 above).

In another preferred form the plastic additive comprises the light stabilizer of the formula (I) and a light stabilizer selected from
butanedioic acid, dimethylester, polymer with 4-hydroxy-2,2,6,6-tetramethyl-1-piperidine ethanol (CAS 65447-77-0),
poly[[6-[(1,1,3,3-tetramethylbutyl) amino]-1,3,5-triazine-2,4-diyl][(2,2,6,6-tetramethyl-4-piperidinyl) imino]-1,6-hexanediyl[(2,2,6,6-tetramethyl-4-piperidinyl) imino]]) (CAS 71878-19-8),
polymer of 2,2,4,4-tetramethyl-7-oxa-3,20-diazadispiro[5.1.11.2]heneicosan-21-one hydrochloride and epichlorohydrin hydrolyzed (CAS 202483-55-4),
1,6-hexanediamine, N, N′-bis(2,2,6,6-tetramethyl-4-piperidinyl)-, polymers with morpholine-2,4,6-trichloro-1,3,5-triazine (CAS 193098-40-7)
1,2,3,4-butanetetracarboxylic acid, polymer with 2,2-bis(hydroxymethyl)-1,3-propanediol and 3-hydroxy-2,2-dimethylpropanal, 1,2,2,6,6-pentamethyl-4-piperidinyl ester (CAS 101357-36-2),
tetrakis(1,2,2,6,6-pentamethyl-4-piperidyl)1,2,3,4-butanetetracarboxylate (91788-83-9),
tetrakis(2,2,6,6-tetramethyl-4-piperidyl)-1,2,3,4-butanetetracarboxylate,
linear or cyclic condensates of N,N′-bis(2,2,6,6-tetramethyl-4-piperidyl)-hexamethy-lenediamine and 4-morpholino-2,6-dichloro-1,3,5-triazine,
a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]),
a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]),
a reaction product of maleic acid anhydride-α-olefin copolymer with 2,2,6,6-tetramethyl-4-aminopiperidine,
1,3,5-triazine-2,4,6-triamine, N, N′″-[1,2-ethane-diyl-bis [[[4,6-bis-[butyl (1,2,2,6,6-pentamethyl-4-piperidinyl) amino]-1,3,5-triazine-2-yl]imino]-3,1-propanediyl]]bis [N′, N″-dibutyl-N′, N″-bis(1,2,2,6,6-pentamethyl-4-piperidinyl) (CAS 106990-43-6), and
the light stabilizer of formula (II).

### Step b)

The step b) is optionally mixing the additive solutions.

The additives solutions are usually those obtainable from step a). In a preferred form, one additive solution is provided in step a), and the optional step b) does not apply.

In another preferred form, at least two additive solutions are provided in step a), and step b) does apply. In another preferred form, at least two additive solutions are provided in step a), and mixed in step b).

The mixing of the additive solutions can be achieved batch wise or continuously. The mixing of the additive solutions can be achieved continuously by a static mixer, for example while feeding to next step (c). Alternatively, the mixing can be done batchwise or continuously in a mixing vessel from which the feed to (c) is continuously drawn.

The mixing of the additive solutions can be done at room temperature or at elevated temperatures, e.g. up to a few degrees below the boiling point of the solution, e.g. from 10 to 100° C.

The additive solutions can be mixed at any desired weight ratio.

### Step c)

The step c) is the thin film evaporation of the additive solution to produce the concentrated additive.

The concentrated additive is usually a liquid. The concentrated additive may comprise from 0.5 to 20 wt %, preferably from 1 to 15 wt %, and in particular from 2 to 10 wt % of the solvent, e.g. the solvent(s) used in the additive solutions of step a).

During the thin film evaporation the solvent concentration is preferably reduced to produce the concentrated additive which comprises less than 10 wt % of the solvent, preferably less than 5 wt %. During the thin film evaporation the solvent concentration is in another form preferably reduced to produce the concentrated additive which comprises less than 8 wt % of the solvent, preferably less than 7 wt %.

The thin film evaporation may refer to a method for continuous evaporating the solvent from a thin film of the additive solution under reduced pressure and optionally elevated temperature.

The thin film of the additive solution can be formed inside or outside on horizontal, inclined, helical or vertical tubes, plates, cylinders or conical shapes. A direct current or counter-current solvent vapor flow can be applied. The thin film may have a thickness of 0.01 to 10 mm, or 0.1 to 5 mm.

Suitable devices for thin film evaporation are thin film evaporators, helical tube evaporators, falling film evaporators or rising film evaporator. Suitable designs of the devices are rotary evaporators which includes self-circulation or forced-circulation evaporator, tubular evaporator, through-circulation evaporator or plate evaporator. The devices for thin film evaporation may comprises additional mechanical elements like wipers, which may support the formation and maintenance of the thin film. Such wipers can be used in shell-and-tube evaporators, where the wipers may be fixed to the surface of a rotating inner tube and the thin film is transported on the inner surface of the exterior cylinder.

The temperature and vacuum of the thin film evaporation can be adjusted to the boiling points solvents which are evaporated. Typically, the temperature of the thin film evaporation is from 20 to 350° C., preferably from 40 to 270° C. In another form, the temperature of the thin film evaporation is from 110 to 220° C., preferably from 140 to 190° C. Often heating jackets are used to adjust the temperature. Typically, the vacuum of the thin film evaporation is from 1 to 900 mbar, preferably from 10 to 500 mbar. The residence time in the evaporator can be from 10 seconds to 10 minutes and preferably 10 seconds to 5 minutes.

### Step d)

The step d) is the agitation of the concentrated additive under vacuum to produce a hot melt.

The agitation of the concentrated additive can be made by extrusion or kneading, preferably by extrusion.

The agitation can be made by known devices, such as in a single-screw extruder, multi-screw extruder, or a kneader, where multi-screw extruders are preferred.

Single-screw extruders include for example those having an axial oscillating screw.

Suitable multi-screw extruders are twin-screw extruders, ring extruders, and planetary roller extruders, where planetary roller extruders are preferred.

Twin screw extruders are for example counter-rotating intermeshing, counter-rotating non-intermeshing, co-rotating intermeshing and co-rotating non-intermeshing twin screw extruders.

Planetary roller extruders may have kneading elements like tooth shaped rollers or rollers with grooves and clearances. The extruder unit may comprise one or more conveying sections and one or more accumulating sections.

In a preferred form the agitation of the concentrated additive is made by extrusion in a single-screw extruder. In another preferred form the agitation of the concentrated additive is made by extrusion in a multi-screw extruder. In another preferred form the agitation of the concentrated additive is made by extrusion in a twin-screw extruder. In another preferred form the agitation of the concentrated additive is made by extrusion in a ring extruder. In another preferred form the agitation of the concentrated additive is made by extrusion in a planetary roller extruder.

The devices for agitation (e.g. the multi-screw extruders) are usually temperature-controlled. For example, the housing and screw of the devices can be heated individually in a plurality of zones, e.g. using double-jacket heating. The agitation (preferably the extrusion) is usually made at a temperature of 20 to 300° C., preferably 80 to 200° C. In another form the agitation (preferably the extrusion) is made at a temperature of 120 to 250° C., preferably 140 to 200° C. The temperature during agitation can be adapted to the boiling point of the solvent which can be removed during the agitation.

The agitation (preferably the extrusion) is usually made under a vacuum, e.g. 0.1 to 500 mbar, preferably 1 to 100 mbar. In another form the agitation (preferably the extrusion) is made under a vacuum below 80 mbar, preferably below 50 mbar. The temperature during agitation can be also adapted to the vacuum which can be applied during the agitation.

The solvent concentration can be reduced during the agitation (preferably the extrusion) under vacuum. During the agitation the solvent concentration may be reduced to produce a hot melt which comprises less than 10.000 ppm of the solvent, preferably less than 5000 ppm. The solvent concentration in the holt melt is usually the same as in the granular plastic additive.

Preferably, the agitation is an extrusion of the concentrated additive under vacuum to produce a hot melt.

In another preferred form, the agitation is an extrusion of the concentrated additive with a multi screw extruder under vacuum to produce a hot melt.

In another preferred form, the agitation is an extrusion of the concentrated additive under a vacuum of 1 to 100 mbar to produce a hot melt.

In another preferred form, the agitation is an extrusion of the concentrated additive with a multi screw extruder under a vacuum of 1 to 100 mbar to produce a hot melt.

In another preferred form, the agitation is an extrusion of the concentrated additive under a vacuum of 1 to 100 mbar to produce a hot melt, where during the extrusion the solvent concentration may be reduced to produce a hot melt which comprises less than 10.000 ppm of the solvent, preferably less than 5000 ppm.

In another preferred form, the agitation is an extrusion of the concentrated additive with a multi screw extruder under a vacuum of 1 to 100 mbar to produce a hot melt, where during the extrusion the solvent concentration may be reduced to produce a hot melt which comprises less than 10.000 ppm of the solvent, preferably less than 5000 ppm.

In another preferred form, the agitation is an extrusion of the concentrated additive under a vacuum of 1 to 100 mbar to produce a hot melt, where during the extrusion the solvent concentration may be reduced to produce a hot melt which comprises less than 20.000 ppm of the solvent, preferably less than 8000 ppm.

In another preferred form, the agitation is an extrusion of the concentrated additive with a multi screw extruder under a vacuum of 1 to 100 mbar to produce a hot melt, where during the extrusion the solvent concentration may be reduced to produce a hot melt which comprises less than 20.000 ppm of the solvent, preferably less than 8000 ppm.

### Step e)

The step e) is the mixing the molten carrier polymer with the concentrated additive during the agitation, which is preferably the extrusion. Usually step d) and step e) are made at the same time.

The mixing of the molten carrier polymer can be made by extrusion of the carrier polymer and feeding it into the hot melt in step d). The extrusion of the carrier polymer can be made by known devices, such as in a single-screw extruder or multi-screw extruder. The extrusion of the carrier polymer is usually made at a temperature of 20 to 300° C., preferably 80 to 200° C. In another form, the extrusion of the carrier polymer is can be made at a temperature of 100 to 200° C., preferably 120 to 180° C. The temperature during extrusion of the carrier polymer can be adjusted to the melting point of the carrier polymer. The temperature during extrusion of the carrier polymer is usually adjusted to melt the carrier polymer.

The granular plastic additive may comprise 1 to 25 wt % of the carrier polymer, preferably 8-12 wt %. The weight ratio for mixing the carrier polymer and the concentrated additive during the extrusion can be adjusted to achieve the desired wt %, e.g. 1 to 25 wt % of the carrier polymer, preferably 8-12 wt %, in the granular plastic additive.

Suitable carrier polymers are polyolefins, such as polypropylenes or polyethylenes, where polyethylenes are preferred. Preferred carrier polymers are low density polethylenes, e.g. with a density of 0.915 to 0.930 g/cm³.

Suitable polyethylenes are low density polyethylenes, homopolymeric polyethylene waxes (e.g. having an average molecular weight of 2000 to 10,000, preferably 3000 to 8000), copolymeric polyethylene waxes of ethylene with vinyl acetate (VAC), which may have a VAC content of 2 to 30% by weight, preferably 5 to 20% by weight, and which may have an average molecular weight of 2,000 to 10,000, preferably 3,000 to 8,000.

Suitable polypropylenes are homopolymeric polypropylene waxes (e.g. having an average molecular weight of 2,000 to 10,000, preferably 3,000 to 8,000), and copolymeric polypropylene waxes.

### Step f)

The step f) is the cooling and forming the hot melt comprising the plastic additive and the carrier polymer to produce the granular plastic additive.

The outlet nozzle of the kneader or the extruder may have orifices, preferably only one orifice, where the hot melt may leave the device.

The cooling of the hot melt can be made with a drum cooler or a belt cooler, where a drum cooler is preferred. The hot melt can be rolled out into a thin film, which is then being pressed up against the surface of a cooled drum. The hot melt can be solidified during the cooling. The hot melt can be cooled to a temperature below 60° C., preferably below 40° C.

The forming of the hot melt can be made before, during or after the cooling, preferably after the cooling. Preferably, the hot melt is solidified before the forming.

The forming can be made by rolling, impressing, crushing, or comminuting, where crushing is preferred. Crushing can be achieved in a roll crusher or a roll mill. A combination of a roll crusher or roll mill with a sieve granulator is also possible.

After the granular plastic additive was formed a sieving can be made to achieve the desired particle size, e.g. by selecting an appropriate sieve width. The sieving of the granular plastic additive may result in fines or dust. The fines or dust can be recycled, e.g. by introducing it in the agitation of step d). In another form the fines or dust are recycled by introducing it in the agitation of step d) via step e), e.g by mixing the fines or dust with the carrier polymer.

The granular plastic additive can be of any shape. The granular plastic additives may have the shape of regular or irregular granules, spheres, cubes, prism, pyramids. The granular plastic additives may have a particle size from 0.1 to 10.0 mm, preferably from 0.5 to 5 mm.

In a preferred form the method for preparing the granular plastic additive comprises the steps of
a) providing two additive solutions which comprise the plastic additive and the solvent, where each additive solution contains a different plastic additive and the same or a different solvent,
b) mixing the two additive solutions (e.g. in a static mixer),
c) thin film evaporation of the additive solution to produce a concentrated additive,
d) extrusion of the concentrated additive under vacuum (e.g. in a multi-screw extruder) to produce a hot melt, where the solvent concentration is removed during the extrusion under vacuum,
e) mixing a molten carrier polymer (e.g. a polyolefin) with the concentrated additive during the extrusion, where the mixing is made by extrusion of the carrier polymer and feeding it into the hot melt, and
f) cooling and forming the hot melt comprising the plastic additives and the carrier polymer to produce the granular plastic additive.

In another preferred form the method for preparing the granular plastic additive comprises the steps of
a) providing two additive solutions which comprise the plastic additive and the solvent, where each additive solution contains a different plastic additive and the same or a different solvent, where both additive solutions comprise at least 25 wt % of the solvent,
b) mixing the two additive solutions,
c) thin film evaporation of the additive solution to produce a concentrated additive where during the thin film evaporation the solvent concentration is reduced to produce the concentrated additive which comprises less than 10 wt % of the solvent,
d) extrusion of the concentrated additive under vacuum (e.g. in a multi-screw extruder) to produce a hot melt, where the solvent concentration is removed during the extrusion under vacuum,
e) mixing a molten carrier polymer (e.g. a polyolefin) with the concentrated additive during the extrusion, where the mixing is made by extrusion of the carrier polymer and feeding it into the hot melt, and
f) cooling and forming the hot melt comprising the plastic additives and the carrier polymer to produce the granular plastic additive, where the granular plastic additive comprises 1 to 25 wt % of the carrier polymer.

In another preferred form the method for preparing the granular plastic additive comprises the steps of
a) providing two additive solutions which comprise the plastic additive and the solvent, where each additive solution contains a different plastic additive and the same or a different solvent, where the solvent comprises toluene, xylene, ethylbenzol, trimethylbenzene, isopropylbenzene, diisopropylbenzene, a water-insoluble organic ketone, or mixtures thereof, where both additive solutions comprise at least 25 wt % of the solvent,
b) mixing the two additive solutions,
c) thin film evaporation of the additive solution to produce a concentrated additive where during the thin film evaporation the solvent concentration is reduced to produce the concentrated additive which comprises less than 10 wt % of the solvent,
d) extrusion of the concentrated additive under vacuum (e.g. in a multi-screw extruder) to produce a hot melt, where the solvent concentration is removed during the extrusion under vacuum,
e) mixing a molten carrier polymer which is a polyolefin with the concentrated additive during the extrusion, where the mixing is made by extrusion of the carrier polymer and feeding it into the hot melt, and
f) cooling and forming the hot melt comprising the plastic additives and the carrier polymer to produce the granular plastic additive, where the granular plastic additive comprises 1 to 25 wt % of the carrier polymer, and where the plastic additive comprises a light stabilizer, a UV stabilizer, or a mixture thereof.

In another preferred form the method for preparing the granular plastic additive comprises the steps of
a) providing two additive solutions which comprise the plastic additive and the solvent, where each additive solution contains a different plastic additive and the same or a different solvent, where the solvent comprises toluene, xylene, ethylbenzol, trimethylbenzene, isopropylbenzene, diisopropylbenzene, a water-insoluble organic ketone, or mixtures thereof, where both additive solutions comprise at least 25 wt % of the solvent,
b) mixing the two additive solutions,
c) thin film evaporation of the additive solution to produce a concentrated additive where during the thin film evaporation the solvent concentration is reduced to produce the concentrated additive which comprises less than 10 wt % of the solvent,
d) extrusion of the concentrated additive under vacuum (e.g. in a multi-screw extruder) to produce a hot melt, where the solvent concentration is removed during the extrusion under vacuum,
e) mixing a molten carrier polymer which is a polyolefin with the concentrated additive during the extrusion, where the mixing is made by extrusion of the carrier polymer and feeding it into the hot melt, and
f) cooling and forming the hot melt comprising the plastic additives and the carrier polymer to produce the granular plastic additive, where the granular plastic additive comprises 1 to 25 wt % of the carrier polymer, and where the plastic additive comprises
   a condensate of 1,6-hexanediamine and 2,4,6-trichloro-1,3,5-triazine as well as N,N-dibutylamine and 4-butylamino-2,2,6,6-tetramethylpiperidine, and/or
   a light stabilizer of the formula (I).

The steps a) to f) are usually made in the alphabetic order. The steps c) to f) can be made batch wise or continuously, preferably continuously.

The invention also relates to the granular plastic additive obtainable by the method for preparing the granular plastic additive comprising the steps of
a) providing at least one additive solution which comprises the plastic additive and the solvent,
b) optionally mixing the additive solutions,
c) thin film evaporation of the additive solution to produce the concentrated additive,
d) agitation of the concentrated additive under vacuum to produce the hot melt,
e) mixing the molten carrier polymer with the concentrated additive during the agitation, and
f) cooling and forming the hot melt comprising the plastic additive and the carrier polymer to produce the granular plastic additive

Preferably, the granular plastic additive is obtainable by the method, where the solvent is toluene, xylene, ethylbenzene, trimethylbenzene, isopropylbenzene, or diisopropylbenzene and the solvent concentration in the granular plastic additive is below 5000 ppm.

In another preferred form, the granular plastic additive is obtainable by the method, where the solvent is toluene, xylene, ethylbenzene, trimethylbenzene, isopropylbenzene, or diisopropylbenzene and the solvent concentration in the granular plastic additive is below 10.000 ppm.

Preferably, the granular plastic additive is obtainable by the method, where the solvent is xylene and the solvent concentration in the granular plastic additive is below 5000 ppm. In another preferred form, the granular plastic additive is obtainable by the method, where the solvent is xylene and the solvent concentration in the granular plastic additive is below 10.000 ppm.

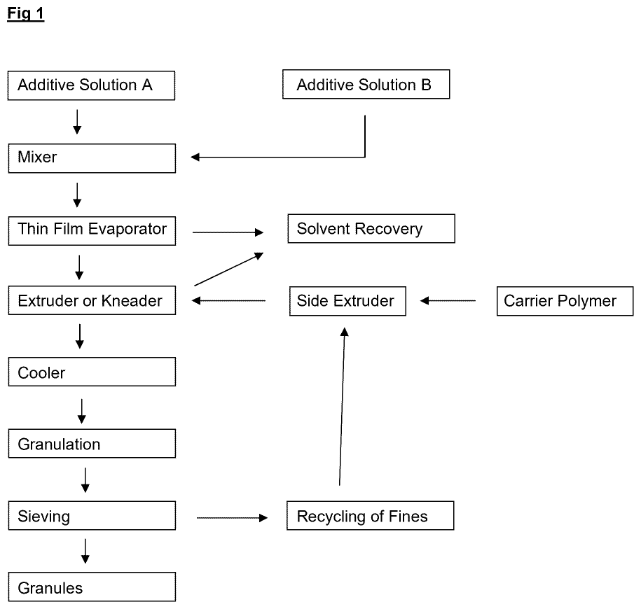

FIG. 1 shows a suitable flow diagram of the method for preparing the granular plastic additive: The Additive Solution A and optionally an Additive Solution B are provided which both comprise the plastic additive and the solvent. The Additive Solution A is optionally mixed (e.g. in a static mixer) with the Additive Solution B if present. The additive solution can be subjected to the thin film evaporation, and the evaporated solvent may be recovered. The produced concentrated additive can then be extruded or kneaded under vacuum, and the evaporated solvent can be recovered. The carrier polymer can be molten in a side extruder and mixed with the concentrated additive. The holt melt may be cooled, granulated and sieved to produce the granular plastic additive. The fines from the sieving may be recycled, e.g. by addition to the extruder.

### EXAMPLES

### Example 1

A solution of about 44 wt % of the light stabilizer of the formula (I) in xylene was prepared and heated to 85° C. The solution was continuously pumped at 560 kg/h in a wiped thin film evaporator. The thin film evaporator was operated under vacuum (about 290 mbar), the jacket was heated with steam; the evaporator and cone heating jacket sections were heated with a controlled pressure of 6 barg, respectively 8 barg. This resulted in a sump temperature of 162° C. The sump contained the liquid concentrated additive, which comprised 2-3 wt % of volatiles.

Subsequently, the sump was continuously pumped at 250 kg/h towards the planetary roller extruder. The extruder was operated with a speed of 150 rpm; the vacuum was maintained at 16, respectively 18 mbar in both sections of the extruder separated by a stop ring, while the temperature of the jacket was maintained at 162° C. on average on the length to produce the hot melt.

A side stream of 25 kg/h of molten (extruder temperature 145-155° C.) low density polyethylene (LDPE, density 0.920 at 23° C. (ISO 1183), melt flow index about 7.8 g/10 min (190° C., 2.16 kg, ISO 1133) was mixed via the side feeder extruder into the hot melt in the planetary roller extruder.

The resulting melt at the outlet of the extruder was cooled on a cooling drum. Granulation happened with a crusher at the cooling drum outlet, followed by a sieve granulator. The final granulues of the light stabilizer of the formula (I) contained 8.9 wt % of LDPE and 0.49 wt % of volatiles.

### Example 2

A solution of about 44 wt % of the light stabilizer of the formula (I) in xylene was prepared and heated to 85° C. The solution was continuously pumped at 780 kg/h in a wiped thin film evaporator. The thin film evaporator was operated under vacuum (about 290 mbar), the jacket was heated with steam; the evaporator and cone heating jacket sections were heated with a controlled pressure of 6 barg, respectively 5 barg. This resulted in a sump temperature of 150° C. The sump contained the liquid concentrated additive, which comprised 5-5.5 wt % of volatiles.

Subsequently, the sump was continuously pumped at 360 kg/h towards the planetary roller extruder. The extruder was operated with a speed of 150 rpm; the vacuum was maintained at at 20, respectively 27mbar in both sections of the extruder separated by a stop ring, while the temperature of the jacket was maintained at 172° C. on average on the length to produce the hot melt.

A side stream of 36 kg/h of molten (extruder temperature 145-155° C.) low density polyethylene (LDPE, density 0.920 at 23° C. (ISO 1183), melt flow index about 7.8 g/10 min (190° C., 2.16 kg, ISO 1133) was mixed via the side feeder extruder into the hot melt in the planetary roller extruder.

The resulting melt at the outlet of the extruder was cooled on a cooling drum. Granulation happened with a crusher at the cooling drum outlet, followed by a sieve granulator. Subsequently, the product was sieved and the fine fraction <1 mm was recycled into the extruder (flowrate 40 kg/h) via the same side feeder as LDPE.

The final granulues of the light stabilizer of the formula (I) contained 9.5 wt % of LDPE and 0.33 wt % of volatiles.

### Example 3

A solution of about 43 wt % of the light stabilizer of the formula (I) in xylene was prepared and heated to 85° C. The solution was continuously pumped at 770 kg/h in a wiped thin film evaporator. The thin film evaporator was operated under vacuum (about 290 mbar), the jacket was heated with steam; the evaporator and cone heating jacket sections were heated with a controlled pressure of 6 barg, respectively 8 barg. This resulted in a sump temperature of 148° C. The sump contained the liquid concentrated additive, which comprised 5.5-6 wt % of volatiles.

Subsequently, the sump was continuously pumped at 350 kg/h towards the planetary roller extruder. The extruder was operated with a speed of 150 rpm; the vacuum was maintained at at 7, respectively 23 mbar in both sections of the extruder separated by a stop ring, while the temperature of the jacket was maintained at 166° C. on average on the length to produce the hot melt.

A side stream of 37.5 kg/h of molten (extruder temperature 145-155° C.) low density polyethylene (LDPE, density 0.920 at 23° C. (ISO 1183), melt flow index about 7.8 g/10 min (190° C., 2.16 kg, ISO 1133) was mixed via the side feeder extruder into the hot melt in the planetary roller extruder.

The resulting melt at the outlet of the extruder was cooled on a cooling drum. Granulation happened with a crusher at the cooling drum outlet, followed by a sieve granulator. The final granulues of the light stabilizer of the formula (I) contained 10.2 wt % of LDPE and 0.25 wt % of volatiles.

1. A method for preparing a granular plastic additive comprising the steps of
a) providing at least one additive solution which comprises a plastic additive and a solvent,
b) optionally mixing the additive solutions,
c) thin film evaporating the additive solution to produce a concentrated additive,
d) agitating the concentrated additive under vacuum to produce a hot melt,
e) mixing a molten carrier polymer with the concentrated additive during the agitation, and
f) cooling and forming the hot melt comprising the plastic additive and the carrier polymer to produce the granular plastic additive.

2. The method according to claim 1, wherein the agitating is performed by extrusion or kneading.

3. The method according to claim 1, wherein the agitating is performed by a single-screw extruder, multi-screw extruder, or a kneader.

4. The method according to claim 1, wherein the solvent concentration is reduced during the agitation under vacuum.

5. The method according to claim 1, wherein, during the agitation, the solvent concentration is reduced to produce a hot melt which comprises less than 10.000 ppm of the solvent.

6. The method according to claim 1, wherein the mixing of the molten carrier polymer is performed by extrusion of the carrier polymer and feeding it into the hot melt in step d).

7. The method according to claim 1, wherein the carrier polymer is a polyolefin.

8. The method according to claim 1, wherein the granular plastic additive comprises 1 to 25 wt % of the carrier polymer.

9. The method according to claim 1, wherein the solvent comprises toluene, xylene, ethylbenzol, trimethylbenzene, isopropylbenzene, diisopropylbenzene, a water-insoluble organic ketone, or mixtures thereof.

10. The method according to claim 1, wherein, during the thin film evaporation, the solvent concentration is reduced to produce the concentrated additive which comprises less than 10 wt % of the solvent.

11. The method according to claim 1, wherein in step a) at least two additive solutions were provided and mixed in step b).

12. The method according to claim 1, wherein the plastic additive comprises a light stabilizer, a UV stabilizer, or a mixture thereof.

13. The method according to claim 1, wherein the plastic additive comprises the light stabilizer of the formula (I) 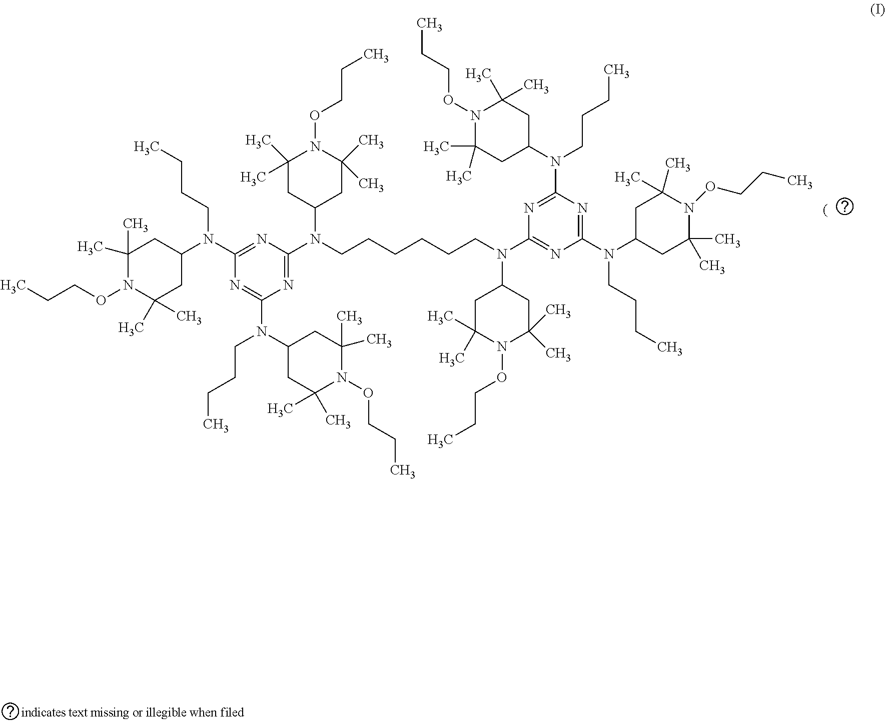 [SMILES: CCCCN(c1nc(N(CCCC)C2CC(C)(C)N(OCCC)C(C)(C)C2)nc(N(CCCCCCN(c2nc(N(CCCC)C3CC(C)(C)N(OCCC)C(C)(C)C3)nc(N(CCCC)C3CC(C)(C)N(OCCC)C(C)(C)C3)n2)C2CC(C)(C)N(OCCC)C(C)(C)C2)C2CC(C)(C)N(OCCC)C(C)(C)C2)n1)C1CC(C)(C)N(OCCC)C(C)(C)C1]
and optionally a light stabilizer selected from the sterically hindered amines.

14. The method according to claim 1, wherein the forming is performed after cooling by comminution.

15. A granular plastic additive obtainable by the method of claim 1.

16. The granular plastic additive according to claim 15, wherein the solvent is xylene and the solvent concentration in the granular plastic additive is below 10.000 ppm.

17. The method according to claim 1, wherein the forming is performed after cooling by milling.
